(19) United States
(12) Patent Application Publication
(10) Pub. No.: US 2002/0150076 A1
(43) Pub. Date: Oct. 17, 2002

(54) Method for playing real time game between cellular phones

(76) Inventors: Cheng-Shing Lai, Taipei Hsieng (TW); Wei-Feng Gu, Taipei Hsieng (TW)

Correspondence Address: BACON & THOMAS, PLLC, 625 Slaters Lane, 4th Floor, Alexandria, VA, 22314-1176, US

(21) Appl. No.: 09/835,362

(22) Filed: Apr. 17, 2001

(51) Int. Cl. H04J 3/24

(52) U.S. Cl. 370/349; 370/469

(57) ABSTRACT

A packet of a communication protocol for communicating real time game data so as to effect a method for playing a real time game between two cellular phones is disclosed. A plurality of protocol data units (PDUs) are contained in the packet. Different data about real time game are contained in the PDUs. Hence, one cellular phone may transmit the packet to the other remote cellular phone. The other cellular phone may process data based on the communication protocol for permitting users to play a real time game therebetween.

### FIELD OF THE INVENTION

The present invention relates to cellular phones and more particularly to a method for playing a real time game between cellular phones.

### BACKGROUND OF THE INVENTION

Recently, there is a trend of developing slim cellular phones among cellular phone manufacturers. Further, the functions of a cellular phone may incorporate features of many consumer electronic products to form a multifunctional cellular phone. For example, a cellular phone having built-in modem and installed communication software may connect to server of the Internet for downloading information therefrom or uploading information thereto. In other words, this is a cellular phone having the capability of accessing the Internet. Further, a cellular phone may have a variety of installed video games for playing. Hence, user may play games for entertainment while not using the cellular phone. At this time, the cellular phone is like a palm sized video game machine. Furthermore, a cellular phone having an embedded infrared device may communicate with another cellular phone having the same embedded infrared device through the infrared devices. Hence, one user holding a cellular phone having installed games and embedded infrared device may play the same game with another user holding a cellular phone having the same capability. However, users may feel dull after playing such games for a period of time. Thus, users may not want to play it anymore in extreme cases. This has departed from the purpose of designing such cellular phones. As to cellular phone having an embedded infrared device, only the dullness of one man play is eliminated. As to the problem of incapable of finding another on line user who is playing a game, such cellular phone having an embedded infrared device does not provide a solution thereto. This is inconvenient. Thus improvement exists.

### SUMMARY OF THE INVENTION

It is an object of the present invention to provide a method implemented in cellular phones comprising transmitting real time game data from one cellular phone through a communication protocol, receiving the real time game data at the other remote cellular phone, reading data, and playing a real time game between the cellular phones.

The above and other objects, features and advantages of the present invention will become apparent from the following detailed description taken with the accompanying drawings.

### BRIEF DESCRIPTION OF THE DRAWINGS

FIG. 1 depicts the structure of a packet according to the invention; and

FIG. 2 depicts the structure of a packet of a preferred embodiment according to the invention.

### DETAILED DESCRIPTION OF THE PREFERRED EMBODIMENTS

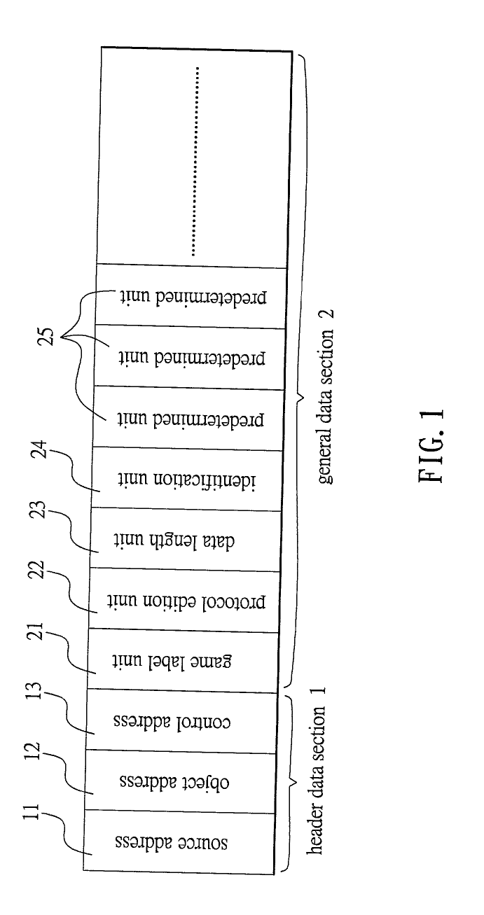

Referring to FIG. 1, there is shown a structure of a packet of a communication protocol for communicating real time game data so as to effect a method for playing a real time game between two cellular phones in accordance with the invention. As shown, a plurality of protocol data units (PDUs) are contained in the packet of communication protocol. Different data about real time game are contained in the PDUs. Hence, one cellular phone may transmit the packet to the other remote cellular phone. Then the other cellular phone may process data based on the communication protocol for permitting users to play a real time game therebetween. In the invention, a communication protocol is implemented for transmitting data from one cellular phone to the other remote cellular phone and browsing data sent from the remote server. In the implementation, data is transmitted in the form of packet. As shown, a packet is comprised of a header data section 1 including a source address 11, an object address 12, and a control address 13 for processing errors and maintaining a normal transmission in the packet and a general data section 2 containing data to be transmitted from one cellular phone to the other remote cellular phone including a game label unit 21 for labeling the packet to be transmitted as real time game data such that the microprocessor of the other cellular phone may identify data contained in the packet as real time game data after reading the packet, a protocol edition unit 22 for labeling the communication protocol utilized in transmitting the packet such that the microprocessor of the other cellular phone may read data contained in the packet by utilizing the communication protocol after reading the packet, a data length unit 23 for indicating the volume of packet to be transmitted such that the microprocessor of the other cellular phone may know the size of data contained in the packet after reading the packet, an identification unit 24 for indicating the kind of game contained in the packet to be transmitted such that the microprocessor of the other cellular phone may know the kind of real time game contained in the packet after reading the packet so as to access a corresponding game software thereafter, and a plurality of predetermined units 25 for containing a variety of data such that the microprocessor of the other cellular phone may process data contained in the packet after reading the packet. In the process of playing, one of the plurality of predetermined units 25 may contain a text message such that user at the other remote cellular phone may enjoy the message when receiving the same. This is for entertainment purpose. Note that most space of the packet is occupied by the general data section 2.

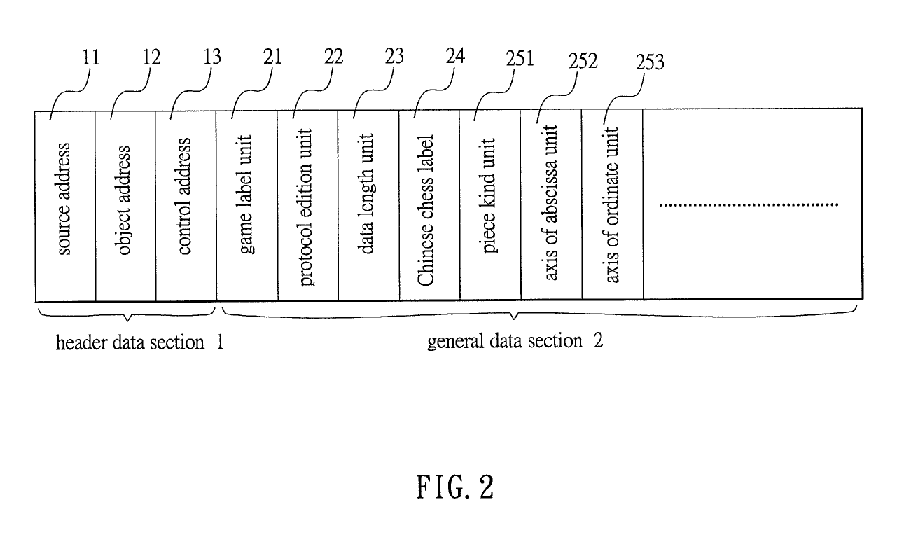

Referring to FIG. 2, there is shown the structure of a packet of a preferred embodiment according to the invention. In the preferred embodiment, a game of Chinese chess is illustrated. As shown, source address 11, object address 12, control address 13, game label unit 21, protocol edition unit 22, and data length unit 23 are the same as that illustrated in FIG. 1. Thus, the description thereof is omitted herein for the sake of brevity. Identification unit 24 is implemented as one containing Chinese chess label. The plurality of predetermined units 25 comprise a piece kind unit 251, an axis of abscissa unit 252 for indicating the horizontal position of the piece, an axis of ordinate unit 253 for indicating the vertical position of the piece, etc. Hence, one user at one cellular phone and another user at the other remote cellular phone may play a Chinese chess therebetween in a real time manner by communicating real time game data in a packet constructed according to the invention.

While the invention has been described by means of specific embodiments, numerous modifications and variations could be made thereto by those skilled in the art without departing from the scope and spirit of the invention set forth in the claims.

What is claimed is:

1. A method for playing a real time game between two cellular phones comprising utilzing a packet of a communication protocol for communicating real time game data, said packet including a plurality of protocol data units (PDUs) for storing a variety of data about said real time game whereby real time game data is transmitted from one of said cellular phones through said communication protocol, said real time game data is received and read at said other cellular phone, said real time game data is processed based on said communication protocol at said other cellular phone, and said real time game is played between said cellular phones.

2. The method of claim 1, wherein said packet comprises a header data section including a source address, an object address, and a control address for processing errors and maintaining a normal transmission in said packet; and a general data section including said plurality of PDUs so as to contain data to be transmitted from one of said cellular phones to said other remote cellular phone.

3. The method of claim 2, wherein said general data section further comprises:
a game label unit for labeling said packet to be transmitted as real time game data such that a microprocessor of said other cellular phone is capable of identifying data contained in said packet as real time game data after reading said packet;
a protocol edition unit for labeling said communication protocol utilized in transmitting said packet such that said microprocessor of said other cellular phone is capable of reading data contained in said packet by utilizing said communication protocol after reading said packet;
a data length unit for indicating volume of said packet to be transmitted such that said microprocessor of said other cellular phone is capable of knowing said size of data contained in said packet after reading said packet;
an identification unit for indicating kind of said real time game contained in said packet to be transmitted such that said microprocessor of said other cellular phone is capable of knowing said kind of said real time game contained in said packet after reading said packet so as to access a corresponding game software thereafter; and
a plurality of predetermined units for containing said variety of data such that said microprocessor of said other cellular phone is capable of processing data contained in said packet after reading said packet.

4. The method of claim 3, further comprising a text message contained in one of said predetermined units, said message being transmitted from one of said cellular phones to said other cellular phone while playing said real time game.
